(19) United States
(12) Patent Application Publication
(10) Pub. No.: US 2006/0156367 A1
(43) Pub. Date: Jul. 13, 2006

(54) System for answering inquiries

(76) Inventor: Norbert Stampfl, Vienna (AT)

Correspondence Address: PHILIPS INTELLECTUAL PROPERTY & STANDARDS, P.O. BOX 3001, BRIARCLIFF MANOR, NY, 10510, US

(21) Appl. No.: 10/531,025

(22) PCT Filed: Oct. 13, 2003
(86) PCT No.: PCT/IB03/04499

§ 371 Date: Apr. 12, 2005

(30) Foreign Application Priority Data
Oct. 17, 2002 (EP) 02102456.7

(51) Int. Cl. H04N 7/173; H04N 7/16

(52) U.S. Cl. 725/118; 725/62; 725/109; 725/110

(57) ABSTRACT

With a reception system (1a) with reception means for receiving a radio signal (MENI, MSFI, MKI) broadcast by a radio station (62), in which radio signal (MENI, MSFI, MKI) inquiry information (FI) is contained, a rapid, direct answering of inquiry information (FI) is enabled. At least one activatable answer input means (31a, 31b) is hereby provided, with which answer input means (31a, 31b), by activation of the same, a generation of answer information (AI) representing an answer option can be issued as the answer to received inquiry information (FI), and wherein answer-information transmission means (53, 24, 8) are provided, with the aid of which the generated answer information (AI) can be transmitted to answer-information reception means (4).

The invention relates to a reception system with reception means for receiving a radio signal broadcast by a radio station, in which radio signal inquiry information is contained.

A reception system as mentioned above is known in connection with an audio apparatus put into trade by the applicant under the type designation FW-i1000. The known apparatus is equipped with reception means for receiving radio programs or entertainment programs broadcast via the Internet and making them available to an audience. An entertainment program of this kind may comprise music or other entertainment information. The entertainment program may hereby be compiled and/or managed or moderated by a so-called moderator. If so desired, the moderator may involve the audience in formulating the entertainment program in that a survey is carried out, for instance by posing the inquiry: “Do you like the music I have put together for you?”, which inquiry is issued as inquiry information via the radio program and received by the audience.

A known option for answering a survey of this kind, i.e. for generating answer information relating to the inquiry information, exists in that a message (letter or email) is composed by a listener, which message is sent to an address announced by the moderator. A disadvantage of this option for answering a survey of this kind consists in the fact that the time span between the issuing of the survey and the reception of answer information is relatively long, which is very disadvantageous. Further, any answer information can be evaluated only by reading the message, which can be relatively laborious and time-consuming, which is also extremely disadvantageous, especially if great many answer informations have to be processed.

A further known option for answering a survey of this kind exists in that answer information is transmitted to the moderator by telephone, wherein the moderator usually announces a telephone number, which telephone number can be called by the audience for the purpose of transmitting the answer information. The disadvantage here is that a relatively long time span is again necessary for transmitting answer information, especially if a relatively large number of calls has to be processed, wherein a disadvantageous overloading may also occur at the moderator's telephone call center. In addition, telephone charges are incurred by the listeners, which is disadvantageous.

As a result of the stated disadvantages, the above-mentioned options or methods for answering a survey diminish, or render impossible, an efficient, direct answering of inquiry information posed by a moderator in order to modify and/or moderate the entertainment program in line with the audience. Addresses and/or telephone numbers announced by the moderator can very easily be misunderstood or incorrectly understood or even not understood at all. Further, a participation rate is relatively low with the stated options, since relatively complex actions are required on the part of the audience in respect of answering the inquiry information, for which actions additional apparatus is required and has to be operated.

It is the object of the invention to eliminate the above-mentioned limitations and problems, and to create an improved reception system of the generic type cited above, in which the above-stated problems are avoided.

To achieve the above-mentioned object, features in accordance with the invention are provided in a reception system in accordance with the invention, so a reception system in accordance with the invention may be characterized in the manner stated below, namely reception system with reception means for receiving a radio signal broadcast by a radio station, in which radio signal inquiry information is contained, wherein at least one activatable answer input means is provided, with which answer input means, by activation of the same, a generation of answer information representing an answer option can be issued as the answer to received inquiry information, and wherein answer-information transmission means are provided, with the aid of which the generated answer information can be transmitted to answer-information reception means.

Through the provision of the features in accordance with the invention, an improved reception system is obtained in a simple manner, wherein an important improvement consists in the fact that a rapid, direct answering of inquiry information can be undertaken. The answer input means hereby advantageously takes the form of means provided directly in the reception system.

Known from document US 2002 0053 077 A is a feedback method and a feedback device for issuing and collecting and providing feedback information regarding radio transmissions. With this known method, the feedback information is issued in an unprompted manner, i.e. without receiving inquiry information. In a feedback method of this kind, the issuing of feedback information could also take place after a receipt of inquiry information. With this feedback method and with this feedback device, to issue the feedback information by electronic means, a questionnaire is selected from a multiplicity of questionnaires and made available, wherein the questionnaire can be transmitted as answer information to answer-information reception device. The completion of a questionnaire of this kind as answer information is very disadvantageous, especially in respect of the generation of answer information as rapidly and conveniently as possible. Also disadvantageous with this feedback method and with this feedback device is the fact that memory means have to be provided, in which memory means the multiplicity of questionnaires is stored. Further, a display device for displaying a questionnaire is required, which is disadvantageous.

It has proved especially advantageous if, in a reception system in accordance with the invention, the features as claimed in claim 2 are additionally provided. It is thereby achieved that answer information can be transmitted to the answer-information reception device in a simple manner and with simple means.

Through the provision of the features claimed in claim 3, the advantage is achieved that conventional reception apparatuses can be used.

Through the provision of the features claimed in claim 4, the advantage is achieved that the characteristic information can be generated relatively rapidly and reliably, wherein no further actions or steps have to be performed in answering the inquiry information.

Through the provision of the features claimed in claim 5, a generation of the characteristic information is equally possible in cases where a radio signal contains no information capable of generating characteristic information.

Through the provision of the features claimed in claim 6, the advantage is achieved that the initiation and transmission of answer information can be undertaken in a convenient manner.

The above aspects and further aspects of the invention are explained below.

The invention will be further described with reference to examples of embodiments shown in the drawings, to which, however, the invention is not restricted.

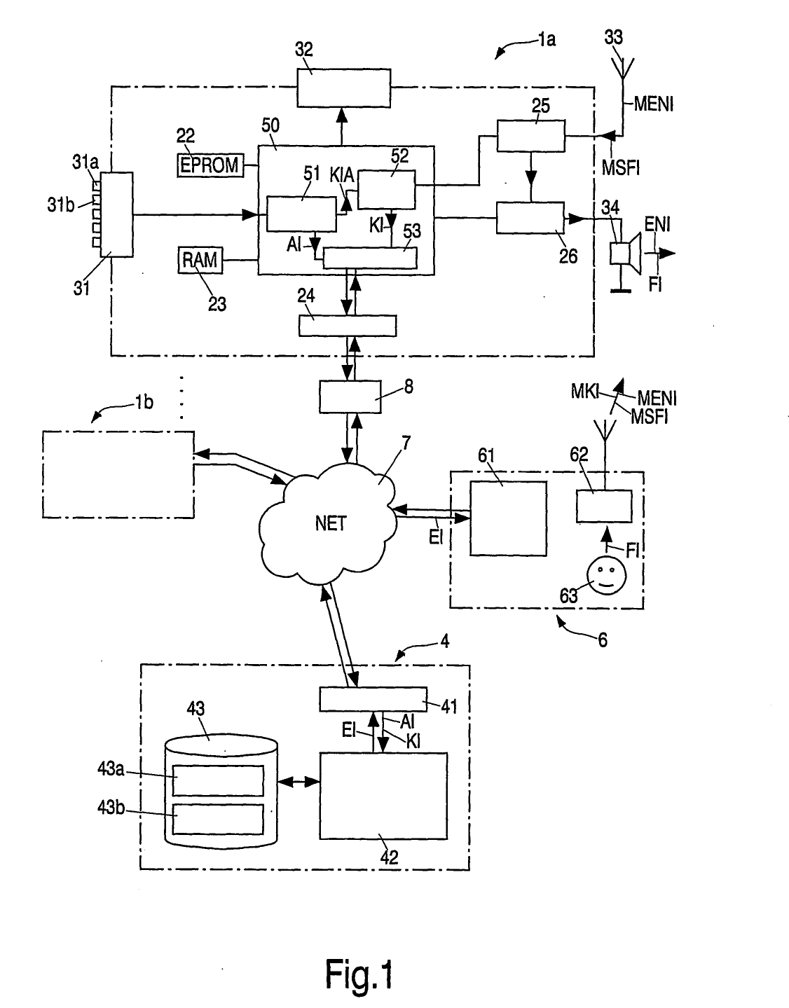

FIG. 1 shows, in a schematic manner, in the form of a block diagram, a part of an apparatus in accordance with a first embodiment of the invention that is significant in the present context; and

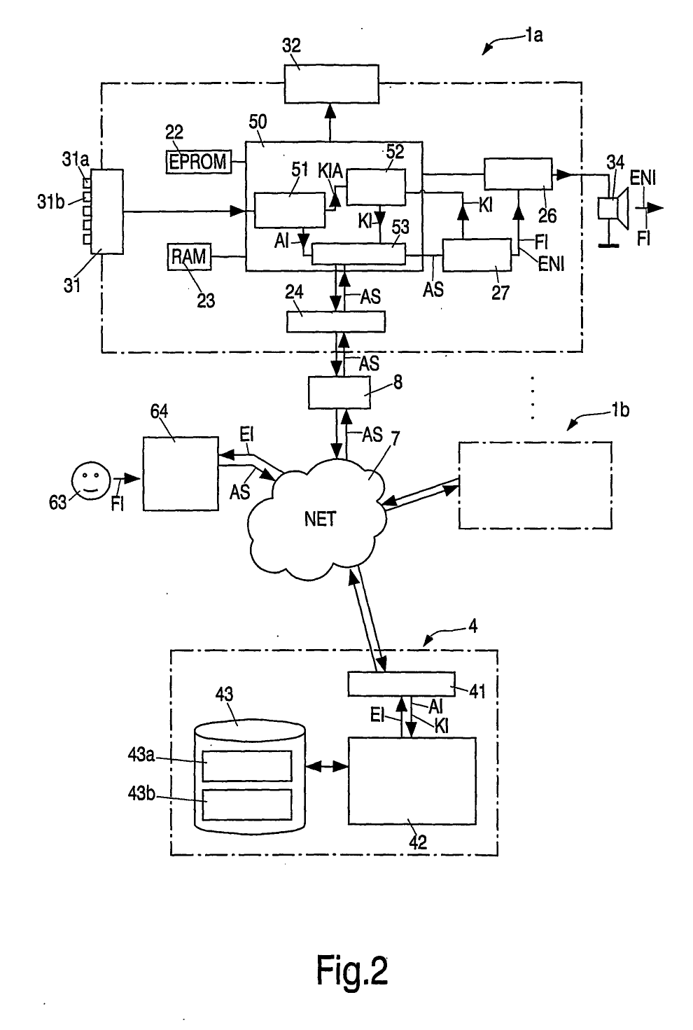

FIG. 2 shows, in a schematic manner, in the form of a block diagram, a part of an apparatus in accordance with a second embodiment of the invention that is significant in the present context.

FIG. 1 shows, as the reception system, an audio apparatus 1a. The audio apparatus 1a is designed to undertake a radio-program reproduction and an audio signal reproduction. Audio apparatus 1a is equipped with a system controller 50, which system controller 50 takes the form of a microprocessor and is connected to a series of data processing means and is designed to control these data processing means, further details of which will be given below. Audio apparatus 1a is further equipped with a data network interface 24, which data network interface 24 is connected to system controller 50 and is designed to communicate data via a modem 8 and a data network 7, and, to this end, is capable of executing appropriate communication protocols. The communication protocol satisfies the “Hyper-Text Transfer/Transmission Protocol” HTTP, which is well known in expert circles, for which reason no further details will be given here. It can be mentioned that the “Simple Network Management Protocol” SNMP may also be used as the communication protocol. It can further be mentioned that the data transmission between data network interface 24 and modem 8 can take place in a different manner, for example in a wireless manner.

In audio apparatus 1a, system controller 50 is connected to multiple means, namely to a tuner module 25, which is designed to receive radio programs from various radio stations via an antenna 33, and to an amplifier module 26, which is designed to amplify the audio signals. An amplified audio signal is delivered to a loudspeaker 34, which is connected to amplifier module 26. System controller 50 is further connected to input means 31 and to output means 32, which input means 31 are designed for inputting control information, and which output means 32 is designed for issuing output signals. In the present case, the input means 31 are buttons, wherein, inter alia, a “YES” button 31a and a “NO” button 31b are provided. It may be mentioned that input means 31 of this kind may equally take the form of a so-called touchscreen, a multifunctional remote control device, a speech control device or a personal computer (PC). The output means 32 in the present case is an LCD dot matrix display unit. It may be mentioned that output means 32 of this kind may also take the form of a VFD display device with Starburst format. Further connected to system controller 50 are a non-volatile memory 22 (EPROM) and a volatile memory 23 (RAM), which memories 22 and 23 are provided and designed for known purposes and for the functionality of system controller 50. System controller 50 is equipped with answer-information generation means 51, characteristic-information delivery means 52 and protocol interface means 53, wherein the protocol interface means 53 is connected to the data network interface 24. The answer-information generation means 51 is connected to input means 31 and characteristic-information delivery means 52, and is designed to deliver answer information AI to protocol interface means 53. The characteristic-information delivery means 52 is connected to the tuner module 25 and designed to deliver characteristic information KI to protocol interface means 53.

As already mentioned, audio apparatus 1a is designed to reproduce a radio program. A radio program of this kind is created in, for example, a system 6 for creating a radio program—as shown in FIG. 1. In the present case, songs are put together by a moderator 63 to form an entertainment program. The entertainment program is transmitted as modulated entertainment information MENI, on a particular transmission frequency, via a radio station 62. There is a wish on the part of the moderator to come into contact with the audience and to obtain an immediate feedback or reaction from the audience in order that, if applicable, this may influence the compilation of the entertainment program. A feedback of this kind on the part of the audience can be undertaken in a very simple manner with the reception system 1a.

For example, the moderator poses the inquiry: “Would you like to listen to this song?” This inquiry is transmitted to the listeners live as inquiry information FI, via radio station 62, as modulated inquiry information MSFI. Inquiry information MSFI of this kind is received by antenna 33 of audio apparatus 1a and delivered to tuner module 25. The modulated inquiry information MSFI is then demodulated by tuner module 25, and delivered as inquiry information FI via amplifier module 26 and loudspeaker 34 to the audience or to a listener, and is heard by the latter. Depending on the listener's decision, an activation of the “YES” button 31a or the “NO” button 31b can take place as a reaction to the heard inquiry information FI. In the present case, “NO” button 31b is activated, after which the generation of answer information AI is initiated in answer-information generation means 51, wherein a code for the activated “NO” button 31b is contained in answer information AI, which code is represented by the number two (2) in the present case. As a result of the generation of answer information AI, a delivery of characteristic-information inquiry signal KIA is initiated in answer-information generation means 51, which characteristic-information inquiry signal KIA is delivered to the characteristic-information delivery means 52, whereupon the determination and delivery of characteristic information KI in respect of the received radio signal is actioned in characteristic-information delivery means 52. In the present case, the characteristic information KI is determined from so-called RDS data of the radio signal, wherein a name of the radio station transmitting the radio signals is hereby determined from the RDS data. In the present case, it may be assumed that the name “Radio OE3” is determined. The answer information AI and the characteristic information KI are brought together in protocol interface means 53 and transmitted as a so-called HTTP POST message, via data network interface 24, modem 8 and data network 7, to answer-information reception device 4, which answer-information reception device 4 has an HTTP reception address www.myphilips.com. The HTTP reception address is obtained from a memory area of memory 22. The HTTP POST message further has a sender address, which sender address is obtained from a memory area of memory 22.

The answer-information reception device 4 is designed as a server and is equipped with a data network interface 41, answer-information evaluation means 42 and memory means 43. Data network interface 41 is designed to receive and transmit data in accordance with an Internet protocol. In the present case, the HTTP POST message delivered from audio apparatus 1a is received and delivered to answer-information evaluation means 42 as answer information AI and characteristic information KI. Answer-information evaluation means 42 is designed as an application program, which runs or is executed on the server.

The processes described above in connection with a feedback to a moderator can, in principle, be implemented by a wide audience, i.e. by a multiplicity of listeners in the present case, wherein a multiplicity of further audio apparatuses 1b are connected to data network 7, and one answer information AI can be delivered to the answer-information reception device 4 in each case. The answer-information evaluation means 42 of answer-information reception device 4 is designed to process and evaluate such a multiplicity of answer informations AI, wherein, in each case, only one answer information AI is ever processed using the sender address. In the present case, the evaluation takes place in a manner such that a statistic is continuously produced, and this takes place via the code contained in the answer information AI relating to a button activated as the feedback to the inquiry information. During the evaluation, evaluation information EI is obtained, which evaluation information EI is stored in a memory area 43a of memory means 43.

After a time span starting from the arrival of first answer information AI and associated characteristic information KI, evaluation information EI is passed to a voting-result reception device 61 of the system 6 for creating a radio program. In the present case, an email is sent to an email address, which email address is stored in station-address memory means 43b and is directly related to the moderator. The email address is hereby selected as a function of the characteristic information KI that is available in answer-information reception device 4. The voting-result reception device 61 takes the form of a PC, which is designed to receive evaluation information EI by email. Evaluation information EI can thereby be made available to the moderator in a simple manner. The above-mentioned time span, after which evaluation information EI is passed on, is advantageously selected in the range of a few seconds, for instance five (5) seconds. A relatively rapid feedback to the inquiry posed by the moderator is thereby obtained, as a result of which a desired measure on the part of the moderator, namely to match the entertainment program to the wishes of the widest possible audience, can advantageously be implemented relatively rapidly.

It may be mentioned that the characteristic-information delivery means may interact with detection means, which are not shown, which detection means are designed to detect location information. An interaction of this kind is advantageous especially in the event that no RDS data is available, from which RDS data the characteristic information KI can be generated. In a case of this kind, characteristic information KI is generated with the aid of a comparison table from the location information and the transmission frequency of the radio signal currently being received. The comparison table is hereby stored in memory 22. For example, a transmission region of “Vienna” is given as the location information with the aid of input means 31, and the transmission frequency of tuner module 25 currently being received is 99.9 MHz. Using the comparison table, the name “Radio OE3” is determined in this case as the name of the radio station, which name is used as characteristic information KI.

It may be mentioned that the comparison table may be stored in the answer-information reception device 4, and determination of characteristic information KI takes place in answer-information reception device 4.

It may also be mentioned that the characteristic information KI may be obtained by means of input means 31, for example by inputting the name of a radio station currently being received by means of tuner module 25.

It may further be mentioned that no characteristic information KI is determined and delivered, and only answer information AI is delivered. In this case, the voting-result reception device 61 delivers inquiry information to answer-information reception device 4 after a certain time span following the delivery of inquiry information FI on the part of moderator 63, which inquiry information initiates the transmission of evaluation information EI to voting-result reception device 61. In this context, it may be mentioned that evaluation information EI can be shown on a website, which website can be called up from voting-result reception device 61.

In the reception system in accordance with one embodiment of the invention as shown in FIG. 2, the audio apparatus 1a, which is designed as the reception system, comprises, instead of tuner module 25, an Internet audio module 27, which Internet audio module 27 is designed to reproduce radio programs, which radio programs are transmitted via data network 7. In this case, the entertainment program is transmitted as an audio stream AS via an Internet Radio Service Provider 64. Modem 8 is designed as a broadband modem in order to ensure a sufficiently high data transmission rate for audio stream AS. As well as entertainment information ENI, the transmitted audio stream AS comprises inquiry information FI and characteristic information KI.

Internet audio module 27 is connected to protocol interface means 53 and is designed to receive audio stream AS. Internet audio module 27 is further designed to deliver the characteristic information KI to the characteristic-information delivery means 52, and the entertainment information ENI and inquiry information FI to amplifier module 26.

In a manner analogous to that above in connection with the procedure described in FIG. 1, an activation of the “YES” button 31a or the “NO” button 31b by a listener is possible as a reaction to the inquiry information FI in order to provide the moderator 63 with a desired immediate response. The evaluation information EI generated by answer-information reception device 4 is hereby transmitted to the Internet Radio Service Provider 64 and made available to the moderator 63.

It may be mentioned that the Internet Radio Service Provider 64 may, likewise, be equipped with answer-information reception device 4, wherein no email is then sent to a station address accessible to moderator 63 and, consequently, no station-address memory means 43b is required.

It may further be mentioned that the HTTP reception address of answer-information reception device 4 may be obtained by Internet audio module 27 from meta tags of audio stream AS, which HTTP reception address simultaneously constitutes characteristic information KI. For example, an HTTP reception address www.oe3_voteserver.com may be determined, to which HTTP reception address www.oe3_voteserver.com only the answer information AI is transmitted.

It may further be mentioned that time-limitation information may be contained in audio stream AS, which time-limitation information defines a time span, within which time span answer information AI can be delivered. Time-limitation-information evaluation means are hereby provided in audio apparatus 1a, which time-limitation-information evaluation means interact with the answer-information generation means 51, and can enable and/or block the generation of answer information AI. An enabling and/or blocking of the generation of answer information AI may be indicated to the listener, e.g. via display means 32.

In a further reception system in accordance with one embodiment of the invention, a selection menu may be realized by means of display means 32 instead of the “YES” button 31a and the “NO” button 31b.

In a further reception system in accordance with one embodiment of the invention, the “YES button 31a and/or the “NO” button 31b may be contained in a remote control device, which remote control device can transmit corresponding remote control signals to remote-control reception means, wherein the answer-information generation means 51 interacts with the remote-control reception means, wherein the remote control signals can initiate the generation of answer information AI. This gives rise to an especially convenient option for a listener to provide a direct response to an inquiry by moderator 63.

1. A reception system (1a, 1b) with reception means (33, 25; 27) for receiving a radio signal (MENI, MKI; AS) broadcast by a radio station (62; 64), in which radio signal (MENI, MKI; AS) inquiry information (FI) is contained wherein at least one activatable answer input means (31a, 31b) is provided, with which answer input means (31a, 31b), by activation of the same, a generation of answer information (AI) representing an answer option can be issued as the answer to received inquiry information (FI), and wherein answer-information transmission means (53, 24) are provided, with the aid of which the generated answer information (AI) can be transmitted to answer-information reception means (4).

2. A reception system (1a, 1b) as claimed in claim 1, wherein characteristic-information delivery means (52) is additionally provided to deliver characteristic information (KI) that is significant to a radio station (62; 64).

3. A reception system (1a, 1b) as claimed in claim 1, wherein the reception means is designed as a conventional analog signal A/V apparatus or as an Internet radio with digital signal processing or as a PC with A/V functionality.

4. A reception system (1a, 1b) as claimed in claim 2, wherein the characteristic-information delivery means (52) is designed to deliver characteristic information (KI), which can be formed from the radio signal (MENI, MKI; AS).

5. A reception system (1a, 1b) as claimed in claim 2, wherein detection means are additionally provided, with which detection means a detection of location information is enabled, wherein the location information can be used to determine the characteristic information.

6. A reception system (1a, 1b) as claimed in claim 1, wherein the answer input means (31a, 31b) is formed by a remote control device.
